(19) United States
(12) Patent Application Publication
(10) Pub. No.: US 2014/0359484 A1
(43) Pub. Date: Dec. 4, 2014

(54) SYSTEM AND METHOD FOR PROVISION OF COMPUTERIZED ONE-STOP INVITATIONS AND ELIMINATION OF DUPLICATED DATA ENTRY

(71) Applicant: ZooZ Mobile Ltd., Raanana (IL)

(72) Inventors: Ronen MORECKI, Kfar Saba (IL); Oren LEVY, Raanana (IL); Ben Yaniv CHECHIK, Yarhiv (IL); Oded GOLDSTEIN, Givatayim (IL)

(21) Appl. No.: 14/288,547

(22) Filed: May 28, 2014

Related U.S. Application Data
(60) Provisional application No. 61/827,898, filed on May 28, 2013.

(51) Int. Cl. H04L 29/06; G06F 3/0481

(52) U.S. Cl. CPC H04L 65/403; G06F 3/0481
USPC 715/753

(57) ABSTRACT

A system for displaying computerized invitations to end users, the system including an invitation server, networked to a multiplicity of end-user's browsers via a network, and operative to send a response to an individual end-user's browser, wherein said response is operative to command the individual end user's browser to: a. open a window on top of publisher content previously selected by the individual end-user and currently present in user's browser; b. display, inside the window, an invitation including invitation consummation information allowing the individual end user to consummate the invitation, and c. close the window once the individual end user consummates the invitation, thereby returning her or him to said publisher content previously selected by her or him.

### REFERENCE TO CO-PENDING APPLICATIONS

Priority is claimed from U.S. Provisional Patent Application No. 61/827,898 entitled “System and method for computerized in-ad payments without duplicated data entry” and filed 28 May 2013.

### FIELD OF THIS DISCLOSURE

The present invention relates generally to interaction with computerized systems and more particularly to interaction with computerized systems which requires data entry.

### BACKGROUND FOR THIS DISCLOSURE

Users of a desktop or mobile device who interact with computerized invitations e.g. e-commerce ads within a webpage, typically undergo a long and complicated process if they elect to interact with these invitations. The process typically re-directs the users to a separate landing page on a different app or website, which in turn directs the user to fill in particulars. Users typically need to re-enter their particulars in each landing page of each domain serving as an invitation source, and/or remain uncertain as to how securely each such domain stores their details.

Adgregate Markets was a venture which stated, as their goal, to “allow consumers to browse, interact, and ultimately purchase directly within an ad unit. Normal display ads take users away from a publisher's site and bring them to a third-party store, but Adgregate lets users buy products featured in ads without moving away from the page. ShopAds, a widget, was said to “replace any size banner ad . . . . If a user views the ad widget and wants to buy the product it's advertising, they need only to click the description button under the ad and click “add to cart” to buy it. From there, the user can pay directly in the widget by inputting credit card information in a secure buying process.” Competitors to Adgregate included Nooked and Lemonade, which are both said to “also allow publishers to embed an e-commerce widget on their sites, but lead users to the retailer's site for purchases.” Adgregate's technology was said to be “useful to publishers because users can purchase an item in the ShopAd widget without having to ever leave their site.”

Methods for embedding Google forms in email are known.

A hack-deterring system for storing sensitive data records is described in published PCT application WO 2013150530 A1. The system includes a mobile communication system comprising a multiplicity of mobile devices, and a server communicating with the mobile devices via a communication network, and a central database which is in data communication with the server and which is operative for storing sensitive data encrypted using at least one key, at least a portion of which is provided, only on certain occasions, by an individual one of the mobile devices and is not retained between the occasions by the central database.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide a system for presenting invitations and facilitating interaction therewith.

Certain embodiments of the present invention seek to provide a system for presenting invitations to a user interacting with content e.g. of a publisher's website, and facilitating interaction with the invitations if the user expresses a wish to interrupt his interaction with the content e.g. of the publisher's website, in order to interact with and consummate the invitation. Once this occurs, the user is then, typically, returned to the content e.g. of the publisher's website.

The system typically comprises a cross-technology system which interfaces with a variety of web environments, web browsers, mobile devices, iOS and Android environments. Typically, the system is operative to recognize a single end-user coming from multiple invitation sources without requiring that end-user to conventionally “login” anew., e.g. by use of technology such as PCPrinting, PC Fingerprints, etc. Typically, the system is responsive in that the system's code adjusts to the device calling the code. Therefore, an invitation presented responsive to a call from, say, a desktop PC is typically rendered differently than if the same invitation were to have been called from an iPad or iPhone or other mobile device. The system is typically useful for e-commerce applications, for generating an In-Invitation payments system which allows users to pay for goods directly from within online ads. The system is typically an html (e.g. HTML5)-based system which supports a wide variety of web devices. Nonetheless, methods and systems shown and described herein are applicable, e.g. to formats which are not identical to HTML5 (and HTML in general) but have relevant features in common with html generally and HTML5 in particular.

Certain embodiments of the present invention seek to provide a single SDK (software developer kit) operative for enabling invitation sources to allow a user to click/tap on a banner invitation and be immediately presented from within that invitation the product which the user chose to purchase, (without being re-directed to a separate website or app) and asking the user to enter their details only once. Typically, a user's details are stored in a secure environment for their next purchase from this invitation source or any other invitation source they choose, without requiring them to re-enter the details, when clicking/tapping system-enabled ads. Embodiments include

a. A computerized payment system which allows users to pay for goods or services directly from within online ads.
b. A system according to Embodiment a, which enables users to checkout and pay directly from within a clickable online banner invitation that the user views inside a computerized environment.
c. A system according to Embodiment b, wherein said computerized environment comprises an app, a website, a smart tv commercial, or any online media that have an interactive screen and invitation/s.
d. A system according to Embodiment a, wherein after user taps on the invitation, a checkout pops up, showing the user transaction information and enabling the user a one-tap payment.
e. A system according to any of Embodiments a-d, which is packaged in a single SDK (software developer kit).
f. A system according to Embodiment a, wherein the user purchases without being re-directed to a separate website or app.
g. A system according to Embodiment a, wherein the user is asked to enter details only once.
h. A system according to Embodiment g, wherein the user's details are stored in a secure environment for their next purchase from this invitation source or any other invitation source they choose when clicking/tapping ads enabled via this system.

According to certain embodiments, an advertiser domain sends the ad server (offline) all product information. A publisher site (e.g. news site, weather site, sports site etc.) uses many Ad networks and servers, one of them may be the Ad server (or any Ad network the ad server cooperates with).

When an end-user goes to the publisher site and asks to read an article (say), the publisher site server typically gets the request and generates an HTML response back to the client's browser. This HTML response typically also includes code embedded inside it, as the publisher website, when generating the HTML for the end-user, sent a request to the ad server to get the Javascript code to show the ad banner. Typically, once the HTML is downloaded to the end-user's browser, and the end-user clicks the banner, this executes the Javascript code which then typically sends a request to the ad server which may send an HTML response back to the end-user's browser with HTML code that generates:
1. The product page in a hover like window on top of the publisher website (this can be done using IFRAME or any other HTML5 code); and or
2. Blur of the background (the cnn.com article) to generate the feeling that the product page is the enabled window.

Typically, the end-user then clicks the BUY button on the product page, which then sends another Javascript request to the ad server in which the response HTML may now be the checkout page with, (say), credit card details. Once end-user clicks “PAY” on that page, another Javascript may be sent to the ad server with all the payment information, and the ad server may send back the HTML response with the status of the payment (success or failure).

The following terms may be construed either in accordance with the specification, or as follows:

Computerized invitation: content which is typically added to existing content such as a webpage, and which is designed to facilitate user interaction. Invitations may for example include: exhortations to access more information (e.g. by clicking on links) for maintaining safety of at least one of: equipment, humans and data; exhortations to interact with social networks; exhortations to volunteer or to vote; reminders to interact with a computerized system networking with the user's system, which are pre-defined for a community of users; e-commerce ads; updates pertaining to new voice, text or media messages (emails, SMS, etc.) received by the human user on other systems including an invitation to the user to access same; and content recommendations e.g. references to articles and/or media files that the user might wish to access, based on system-learned user characteristics. An invitation is consummated if the end-user decides to accede to the invitation e.g. to access the safety information offered; interact with social networks as suggested; volunteer, vote, purchase via e-commerce, access updates as exhorted; and so on.
Invitation source: domain which provides a computerized invitation. The domain may for example be a computerized government agency, a portal, an advertiser or merchant, a data repository.
One-stop invitation or “in-invitation”: invitation which is added to website1 and does not, when tapped or clicked redirect user to another website, website2 (e.g. website of invitation source). Instead, typically when the invitation is tapped or clicked, information enabling a user to consummate the invitation pops up at website1. If the user then consummates the invitation, responsive processing typically occurs at website1.

The present invention typically includes at least the following embodiments:

### Embodiment 1

A system for displaying computerized invitations to end users, the system including:

An invitation server, networked to a multiplicity of end-user's browsers via a network, and operative to send a response to an individual end-user's browser,

wherein the response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to the publisher content previously selected by her or him.

### Embodiment 2

A system according to any of the preceding embodiments wherein the response comprises html code.

### Embodiment 3

A system according to any of the preceding embodiments wherein IFRAME code is used to command the browser to open a window on top of publisher content currently present in user's browser.

### Embodiment 4

A system according to any of the preceding embodiments wherein the invitation includes more than one page each page including a user input area and wherein when the user engages with the user input area on the i'th page, a request is sent to the invitation server for the (i+1)'th page.

### Embodiment 5

A system according to any of the preceding embodiments wherein the request comprises a Javascript request.

### Embodiment 6

A system according to any of the preceding embodiments wherein the window is smaller than the screen size such that even when the window is open, some publisher content remains visible.

### Embodiment 7

A system according to any of the preceding embodiments wherein the window appears in the screen center and publisher content remains visible in an area peripheral to the window.

### Embodiment 8

A system according to any of the preceding embodiments wherein the response includes an instruction to modify the publisher content which remains visible, so as to focus the end-user's attention on the window rather than on the publisher content which remains visible

### Embodiment 9

A system according to any of the preceding embodiments wherein the instruction to modify includes an instruction to blur the publisher content which remains visible.

### Embodiment 10

A system according to any of the preceding embodiments wherein the instruction to modify includes an instruction to tint the publisher content which remains visible.

### Embodiment 11

A system according to any of the preceding embodiments wherein the instruction to modify includes an instruction to binarize the publisher content which remains visible.

### Embodiment 12

A system according to any of the preceding embodiments wherein the user input area comprises a button and wherein the user engages therewith by at least one of clicking and tapping.

### Embodiment 13

A system according to any of the preceding embodiments wherein the invitation server is also operative, once the end user consummates the invitation, to update affected nodes in the network.

For example, if the invitation is to consummate a transaction between an organ donor and an organ recipient, both represented by domains communicating via the network, then once an end user, acting as a donor, consummates the invitation, its own domain and the domain representing the recipient, are both updated. If the invitation is to consummate an e-commerce transaction between an end user and a merchant, the end user's bank and the merchant's domain, both represented by domains communicating via the network, are both updated. if the invitation is to participate in a survey, the domain initiating the survey is updated to allow survey results to be incremented by the results entered by the end user, etc.

### Embodiment 14

A method for displaying computerized invitations to end users, the method including:

Providing an invitation server, networked to a multiplicity of end-user's browsers via a network, and operative to send a response to an individual end-user's browser

wherein the response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to the publisher content previously selected by her or him.

### Embodiment 15

A computer program product, comprising a non-transitory tangible computer readable medium having computer readable program code embodied therein, the computer readable program code adapted to be executed to implement a method for displaying computerized invitations to end users, the method including:

Using an invitation server, networked to a multiplicity of end-user's browsers via a network, to send a response to an individual end-user's browser wherein the response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to the publisher content previously selected by her or him.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer -usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to steps of flowcharts, may be performed by at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein e.g. by providing one or more modules in the processor/s to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 is a computerized system for presenting invitations and facilitating interaction therewith, constructed and operative according to certain embodiments of the present invention.

FIG. 2 is a simplified flowchart illustration of a method for presenting invitations and facilitating interaction therewith, which may for example serve as an example method of operation for the system of FIG. 1.

FIG. 3 is a simplified flowchart illustration of an e-commerce variation of the method of FIG. 2.

FIG. 4 is a simplified flowchart illustration of an example of a first Use Case for the method of FIG. 3, in which advertisers are selling physical goods that require shipping.

FIG. 5 is a simplified flowchart illustration of an example of a second Use Case for the method of FIG. 3, in which advertisers are selling physical goods that do not require shipping.

FIGS. 6a-6b, taken together, are a simplified flowchart illustration of a variation on the method of FIG. 2 and may for example serve as an example method of operation for the system of FIG. 1. Any of the steps of FIGS. 2, 6 may be combined in any suitable manner

FIGS. 2-6 each typically comprise some or all of the illustrated steps, suitably ordered e.g. as shown.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A system for presenting invitations and facilitating interaction therewith is now described in detail. The system typically presents initial invitation content e.g. as a banner within a first web-page; if the user elects to engage with the initial content e.g. by tapping/clicking thereupon, the system typically presents further content; for example, a second webpage similar to the first webpage except that further content is superimposed thereupon, may be sent to the user's browser. If the user elects to engage with the further content, e.g. by tapping/clicking a specified “button” therewithin (or alternatively, responsive to the initial tap/click on the initial content), still further content is presented. For example, a third webpage (and possibly fourth, fifth etc. webpage/s) may be sent to the user's browser. The third webpage may again be similar to the first webpage except that still further content, allowing the user to consummate the invitation, is superimposed thereupon. Typically, the still further content in the third (and possibly subsequent) webpage/s includes at least one form for the user to fill in. Once this has occurred, including (typically) clicking on a “submit” button, this indicates that the invitation has been consummated and the user is then once again presented with the first web-page (which may or may not have been updated by a publisher thereof in the meantime). In the background, the user-provided information is processed by the system's server. Typically, user-provided information, responsive to invitation A, is stored by the system and is re-presented if the user elects in future to interact with invitation B, consummation of which requires (some of) the same information. It is appreciated that when invitation content is superimposed over the first web-page, a portion of the original content of the first web-page may surround the invitation content, hence remain visible; however this portion may be presented at low intensity so as to focus the user's attention on the invitation content which is typically presented in the center of the screen.

### Example 1

A system for presenting invitations to participate in a computerized survey and facilitating interaction therewith. The system typically presents initial invitation content e.g. as a banner briefly headlining the survey within a first web-page such as a news-page; weather page or any other content page of any suitable publisher; if the user elects to engage with the initial content e.g. by tapping/clicking thereupon, the system typically presents further content. For example, a second webpage similar to the first webpage, except that further content, which is superimposed thereupon, may be sent to the user's browser. The second webpage's further content may present further details about the survey. If the user elects to engage with the further content, e.g. by tapping/clicking a specified “participate-in-survey button” therewithin (or alternatively, responsive to the initial tap/click on the initial content), still further content is presented. For example, a third webpage (and possibly fourth, fifth etc. webpage/s) may be sent to the user's browser. The third webpage may again be similar to the first webpage except that still further content, allowing the user to consummate the invitation, is superimposed thereupon. Typically, the still further content in the third (and possibly subsequent) webpage/s includes at least one form for the user to fill in, such as at least one survey question and multiple-choice answers thereto. Once this has occurred, including (typically) clicking on a “submit” button to finally authorize sending the user's answers back to the system, this indicates that the invitation has been consummated and the user is then once again presented with the first web-page (which may or may not have been updated by a publisher thereof in the meantime). In the background, the user-provided information is processed by the system's server; for example, the user's answers are added to a repository of users' survey answers and suitable statistics are incremented.

### Example 2

A system for presenting invitations to adjust display screen parameters.

Initial invitation content may include a brief message such as: “Want to change anything about the screen display??” If the user elects to engage with this message (e.g. by tapping/clicking), still further content, allowing the user to consummate the invitation, may include at least one question about whether the glare bothers the user, whether the room is dark or light, whether the font is too large or too small or just right, and so forth. Once the user answers these and clicks on a “submit” button, the user is then once again presented with the first web-page (which may or may not have been updated by a publisher thereof in the meantime). In the background, the user-provided information is processed by the system's server and the eventual result is that the screen parameters are automatically adjusted.

### Example 3

A system for presenting invitations, each comprising an e-commerce advertisement. Initial invitation content may be a conventional banner ad. If the user elects to engage with this message (e.g. by tapping/clicking), further information may include a product page typically including a “buy” button. If the user elects to engage (e.g. by tapping/clicking on “buy”) still further content, allowing the user to consummate the invitation, this may include requests for payment and/or shipping particulars. In the background, the resulting e-commerce transaction is processed by the system's server and the eventual result is that the user is provided with a product or service and the user's account is debited using the user-selected payment method. Typically, shipping and other information, provided by an individual user responsive to ad A, is stored by the system and is re-presented if the same user elects in future to interact with ad B, since the transaction with ad B may require the same shipping information, such as the user's address. The same is true, mutatis mutandis, for particulars which may be required for invitations that are not related to e-commerce.

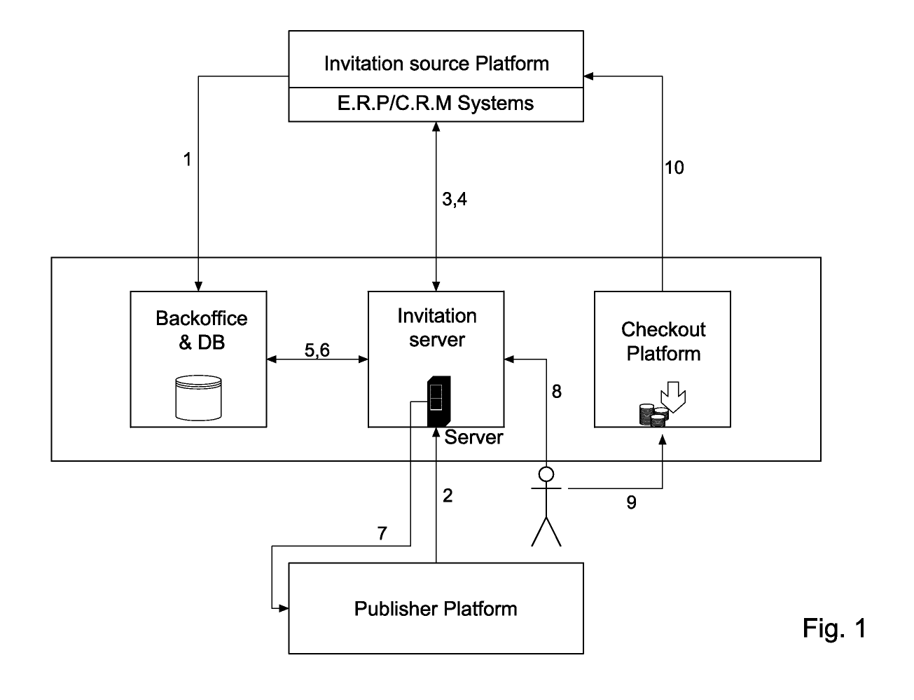

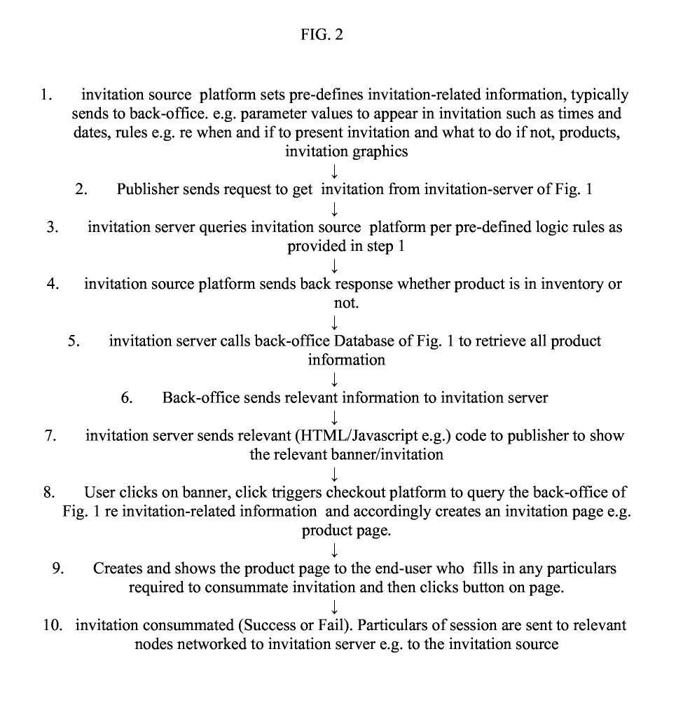

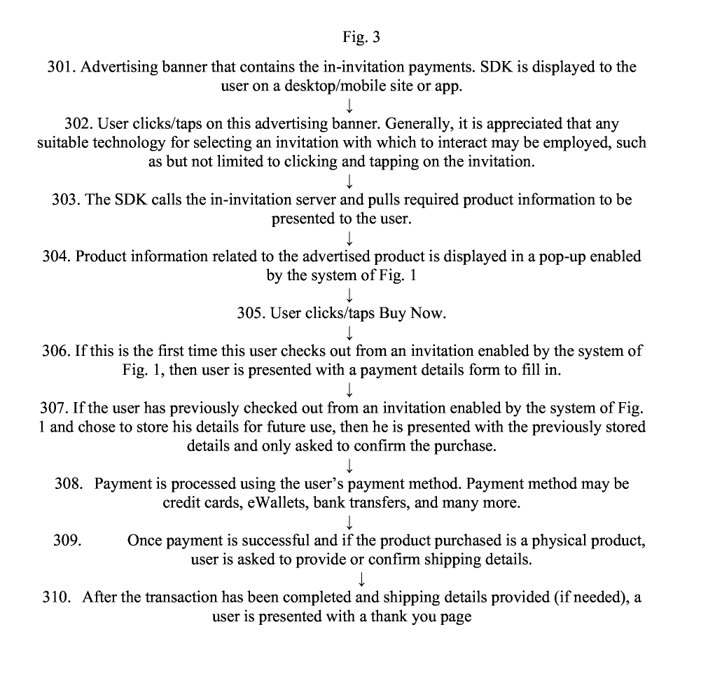

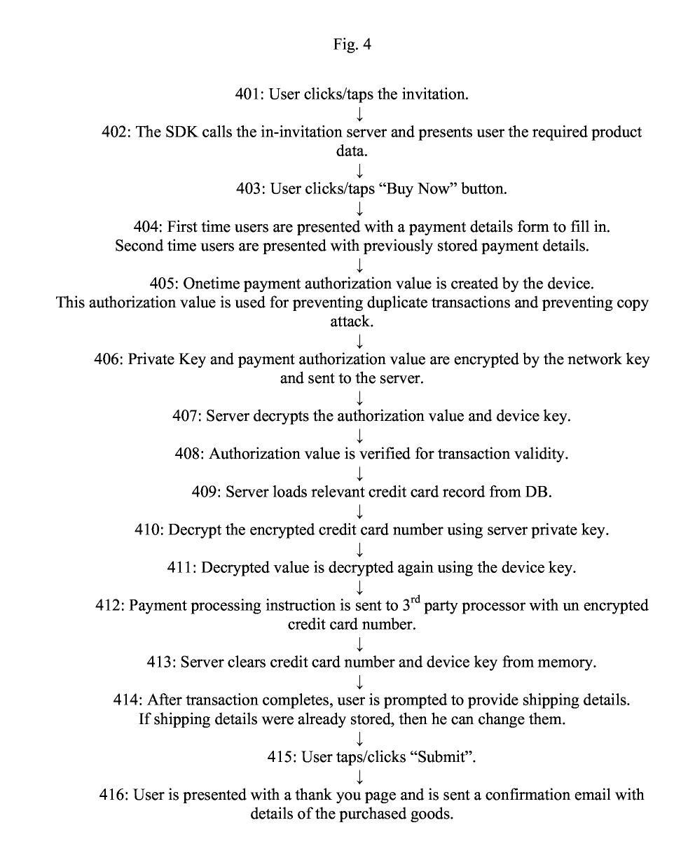

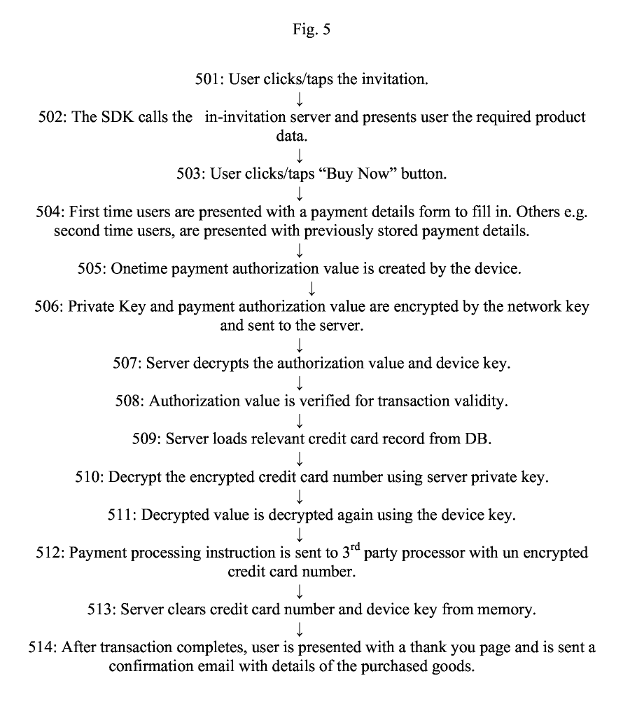

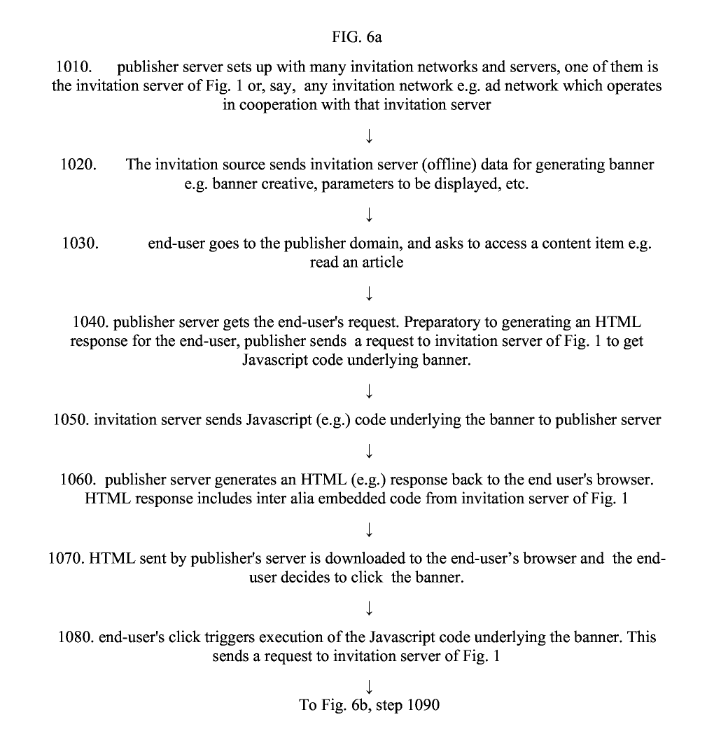

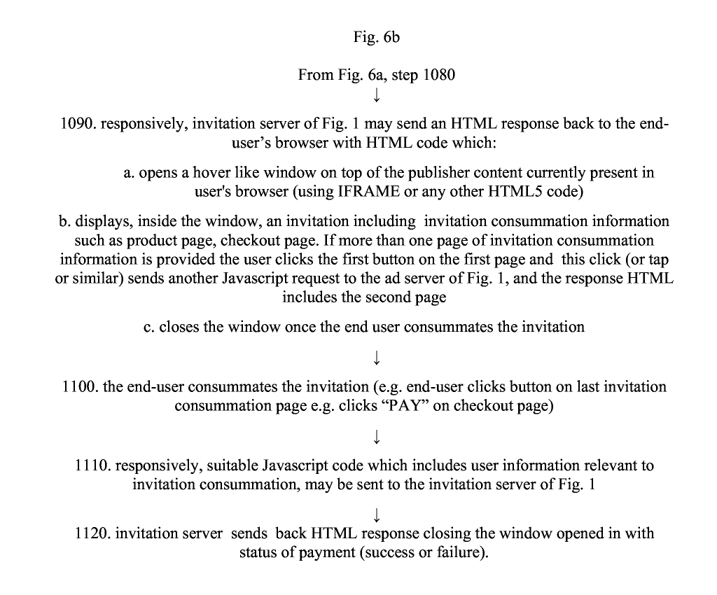

FIG. 1 is a computerized system for presenting invitations and facilitating interaction therewith, constructed and operative according to certain embodiments of the present invention.

FIG. 2 is a simplified flowchart illustration of a method for presenting invitations and facilitating interaction therewith, which may for example serve as an example method of operation for the system of FIG. 1. The operations of FIG. 1 are indicated, by number, on FIG. 1 to denote communication routes between various functional units in the system of FIG. 1, some or all of which may be provided.

The method of FIG. 2 may include some or all of the following steps, suitably ordered e.g. as follows:
1. invitation source platform sets pre-defines invitation-related information, typically sends to back-office of FIG. 1. E.g. parameter values to appear in invitation such as times and dates, rules e.g. re when and if to present invitation and what to do if not, products, invitation graphics
2. Publisher send request to get invitation from invitation-server of FIG. 1
3. invitation server queries invitation source platform per pre-defined logic rules as provided in step 1
4. invitation source platform sends back response whether product in inventory or not.
5. invitation server calls backoffice Database of FIG. 1 to retrieve all product information
6. Back Office sends relevant information to invitation Server
7. invitation server sends relevant (HTML/Javascript e.g.) code to publisher to show the relevant Banner/invitation
8. User clicks on banner, click triggers checkout platform to query the back-office of FIG. 1 re invitation-related information and accordingly creates an invitation page e.g. product page.
9. Creates and shows the product page to the end-user who fills in any particulars required to consummate invitation and then clicks button on page.
10. invitation consummated (Success or Fail). Particulars of session are sent to relevant nodes networked to invitation server eg to the invitation source.

Certain embodiments seek to provide a payment system which enables users to checkout and pay for advertised goods or services directly from within a clickable online banner invitation that the user views inside an app or on a website, or a smart TV commercial or any online media that have interactive screen and ads, thus enabling a quick and seamless purchase process.

After engaging with e.g. clicking or tapping on the invitation, e.g. ad, a checkout may pop up, showing the user the proposed goods for sale and enabling the user a one-tap payment. This is all done without being redirected to a invitation source's site or app for a separate tiresome process, without being prompted to download a different software or app where he may then have to find the product he was looking for, and without the user being required to provide his contact details and then wait for someone to get back to him.

When a user clicks to consummate an invitation, e.g. by click/tapping a “buy” or similar button, e.g. as shown in step 9 of FIG. 2, the technology shown and described in co-pending published PCT application No. WO 2013150530, entitled “Hack-deterring system for storing sensitive data records” may be used to generate a suitable checkout flow within a relevant product page. Any suitable one of the embodiments described in the WO 2013150530 publication may be employed, such as but not limited to any of the following:

### WO 2013150530 Embodiment 1

A mobile communication system comprising: a multiplicity of mobile devices; and a server communicating with the mobile devices via a communication network; and a central database which is in data communication with the server and which is operative for storing sensitive data encrypted using at least one key, at least a portion of which is provided, only on certain occasions, by an individual one of the mobile devices and is not retained between the occasions by the central database.

### WO 2013150530 Embodiment 2

A system according to WO 2013150530 Embodiment 1 wherein the sensitive data is double-encrypted, wherein a second layer of encryption is provided by use of at least one private key known only to the server.

### WO 2013150530 Embodiment 3

A system according to WO 2013150530 Embodiment 2 wherein the at least one private key known only to the server comprises a single key used for all device records.

### WO 2013150530 Embodiment 4

A system according to WO 2013150530 Embodiment 1 wherein the sensitive data comprises a multiplicity of device-specific data records each respectively including an ID identifying a respective one of the multiplicity of mobile devices.

### WO 2013150530 Embodiment 5

A system according to WO 2013150530 Embodiment 4 wherein each individual record from among the multiplicity of device-specific data records is protected with a key at least a portion of which is provided, on occasion, by an individual one of the mobile devices identified by the ID included in the individual record.

### WO 2013150530 Embodiment 6

A system according to WO 2013150530 Embodiment 1 wherein at least a portion of the key is stored aboard the individual one of the mobile devices.

### WO 2013150530 Embodiment 7

A system according to WO 2013150530 Embodiment 1 wherein at least a portion of at least one key is never stored in any permanent storage medium in the central database.

### WO 2013150530 Embodiment 8

A system according to WO 2013150530 Embodiment 1 wherein at least a portion of at least one key is erased from memory of the server, soon after being used by the server subsequent to having been provided, by the individual one of the mobile devices, to the server.

### WO 2013150530 Embodiment 9

A system according to WO 2013150530 Embodiment 1 wherein at least a portion of the key is stored on the server in the clear, only while a single specific key-based operation is performed after which at least a portion of the key is cleared from memory by the server.

### WO 2013150530 Embodiment 10

A system according to WO 2013150530 Embodiment 9 wherein the single specific key-based operation comprises registration of credit card particulars.

### WO 2013150530 Embodiment 11

A system according to WO 2013150530 Embodiment 9 wherein the single specific key-based operation comprises effecting payment to a single vendor for a single device-vendor transaction.

### WO 2013150530 Embodiment 12

A system according to WO 2013150530 Embodiment 1 wherein at least a portion of the key undergoes encryption before it is provided to the server by an individual one of the mobile devices, and undergoes decryption thereafter, using a per-device network key which is created by the server and stored in the database and in the device.

### WO 2013150530 Embodiment 13

A system according to WO 2013150530 Embodiment 5 wherein each key, provided by an individual one of the multiplicity of mobile devices, thereby to define a multiplicity of device-specific keys, undergoes encryption before it is provided to the server, and undergoes decryption thereafter, using a network key specific to the individual one of the multiplicity of mobile devices, whose network key is created by the server and stored in the database, thereby to define a multiplicity of network keys.

### WO 2013150530 Embodiment 14

A system according to WO 2013150530 Embodiment 6 wherein at least a portion of the key is stored on the mobile device's key store and is managed by the device's OS (operating system).

### WO 2013150530 Embodiment 15

A system according to WO 2013150530 Embodiment 1 wherein the key is created by the device.

### WO 2013150530 Embodiment 16

A computerized method for retaining sensitive computer data regarding each of a multiplicity of mobile devices communicating with a computer server via a communication network, the method comprising:

storing sensitive computer data encrypted using at least one cryptographic key (“device key”), in a central computer database which is in data communication with the server; and
accepting at least a portion of the key, only on certain occasions, from an individual one of the mobile devices rather than retaining the portion in the central database between the occasions.

### WO 2013150530 Embodiment 17

A method according to WO 2013150530 Embodiment 16 and also comprising using a first Network key set to encrypt the communication between server and each device.

### WO 2013150530 Embodiment 18

A method according to WO 2013150530 Embodiment 17 wherein the storing comprises:

at each device, encrypting both sensitive personal data associated with the device, and the device key using the first network key set, thereby to generate encrypted information, and sending the encrypted information to the server together with device's ID;
at server, decrypting the encrypted information thereby to yield sensitive data and device key;
at server, double-encrypting the sensitive data with the device key and with a server key comprising a private key that is known to the server, thereby to yield double-encrypted data; and storing the double encrypted data in the database, under device's ID, and discarding the device key.

### WO 2013150530 Embodiment 19

A method according to WO 2013150530 Embodiment 17 wherein the first network key set includes one key per device and each key in the first network key set is generated on the server and sent to the key's corresponding mobile device when an individual mobile device first interacts with the server.

### WO 2013150530 Embodiment 20

A method according to WO 2013150530 Embodiment 17 wherein the first network key set includes a public/private key pair and wherein the public key is sent to at least one device using a computerized public distribution protocol.

### WO 2013150530 Embodiment 21

A method according to WO 2013150530 Embodiment 16 and also comprising using a second network key set to encrypt communication between the server and a clearing house.

### WO 2013150530 Embodiment 22

A method according to WO 2013150530 Embodiment 21 wherein the second network key set 2 includes one key per clearing house and each key in the second network key set is generated for the server and sent by the key's corresponding clearing house e.g. when the clearing house first interacts with the server.

### WO 2013150530 Embodiment 23

A method according to WO 2013150530 Embodiment 22 wherein the second network key set includes a public/private key pair and wherein the public key is sent to the server by at least one clearing house using a computerized public distribution protocol.

### WO 2013150530 Embodiment 24

A method according to WO 2013150530 Embodiment 18 wherein the server verifies validity of the sensitive data with a data clearing house before storing the sensitive data and discarding the device key.

### WO 2013150530 Embodiment 25

A method according to WO 2013150530 Embodiment 17 wherein the storing comprises:

at each device, double-encrypting sensitive data associated with the device, first with the device key and then with the first network key set, thereby to generate double-encrypted information, and sending the double-encrypted information to the server with device ID but without device key;
at server, decrypting one layer of the double-encrypted information thereby to yield sensitive data encrypted using the device key;
encrypting the sensitive data again with a server key yielding double encrypted sensitive data encrypted by both device and server keys; and
at server, storing the sensitive data encrypted using the device key, under device's ID, in the database.

### WO 2013150530 Embodiment 26

A method according to WO 2013150530 Embodiment 18 wherein the sensitive data comprises credit card data.

### WO 2013150530 Embodiment 27

A method according to WO 2013150530 Embodiment 21 and also comprising:

at server, accepting from a device, a payment call including its own (device's) ID, plus device key encrypted using first network key set;
at server, decrypting the device key, using the first network key set; at server, pulling double encrypted data corresponding to the ID included in the payment call, from the database and decrypting the double encrypted data using the device key and server key and discarding the device key.

### WO 2013150530 Embodiment 28

A method according to WO 2013150530 Embodiment 27 and also comprising sending the data as decrypted from the server to a clearing house, encrypted only with a second network key set.

### WO 2013150530 Embodiment 29

A method according to WO 2013150530 Embodiment 16 wherein the sensitive computer data is encrypted using only one encryption performed with a single key formed by combining the device key and a server key known only to the server, such that successful encryption depends both on knowledge private to the device and on knowledge private to the server.

### WO 2013150530 Embodiment 30

A method according to WO 2013150530 Embodiment 20 wherein the sensitive data comprises credit card data.

### WO 2013150530 Embodiment 31

A computer program product, comprising a non-transitory computer usable medium having a computer readable program code embodied therein, the computer readable program code adapted to be executed to implement a method for retaining sensitive computer data regarding each of a multiplicity of mobile devices communicating with a computer server via a communication network, the method comprising:

storing sensitive computer data encrypted using at least one cryptographic key (“device key”), in a central computer database which is in data communication with the server; and
accepting at least a portion of the key, only on certain occasions, from an individual one of the mobile devices rather than retaining the portion in the central database between the occasions.

FIG. 3 is a simplified flowchart illustration of an e-commerce variation of the method of FIG. 2. The method of FIG. 3 may include any subset of the following steps in any suitable order, e.g. as follows:

Step 301. Advertising banner that contains the in-invitation payments SDK is displayed to the user on a desktop/mobile site or app.

Step 302. User clicks/taps on this advertising banner. Generally, it is appreciated that any suitable technology for selecting an invitation with which to interact may be employed, such as but not limited to clicking and tapping on the invitation.

Step 303. The SDK calls the in-invitation server and pulls required product information to be presented to the user.

Step 304. Product information related to the advertised product is displayed in a pop-up enabled by the system of FIG. 1; user can then view more data about the product and choose different versions—color, size, quantity, etc.

Step 305. User clicks/taps Buy Now.

Step 306. If this is the first time this user checks out from an invitation enabled by the system of FIG. 1, then they are presented with a payment details form to fill in.

Step 307. If the user has previously checked out from an invitation enabled by the system of FIG. 1 and chose to store his details for future use, then he is presented with the previously stored details and only asked to confirm the purchase.

Step 308. Payment is processed using the user's payment method. Payment method may be credit cards, eWallets, bank transfers, and many more.

Step 309. Once payment is successful and if the product purchased is a physical product, user is asked to provide shipping details. If these shipping details were already previously provided by the user and stored e.g. by the system of FIG. 1 the details are presented for confirmation only, user does not have to re-enter them.

Note—this phase can also appear immediately after collecting the payment details and before actually creating a transaction on the user's chosen payment method.

Step 310. After the transaction has been completed and shipping details provided (in case they are needed), then a user is presented with a thank you page. Typically, the system is operative for uniquely recognizing each device e.g. via provision and suitable sharing of unique per-device IDs, and for storing payment details securely.

FIG. 4 is an example of a first Use Case for the method of FIG. 3, in which advertisers are selling physical goods that require shipping. The method of FIG. 4 may include any subset of the following steps in any suitable order and may employ teachings of published PCT application WO 2013150530.

Step 401: User clicks/taps the invitation.

Step 402: The SDK calls the in-invitation server and presents user the required product data.

Step 403: User clicks/taps “Buy Now” button.

Step 404: First time users are presented with a payment details form to fill in. Second time users are presented with previously stored payment details.

Step 405: Onetime payment authorization value is created by the device. This authorization value is used for preventing duplicate transactions and preventing copy attack.

Step 406: Private Key and payment authorization value are encrypted by the network key and sent to the server.

Step 407: Server decrypts the authorization value and device key.

Step 408: Authorization value is verified for transaction validity.

Step 409: Server loads relevant credit card record from DB.

Step 410: Decrypt the encrypted credit card number using server private key.

Step 411: Decrypted value is decrypted again using the device key.

Step 412: Payment processing instruction is sent to 3^{rd} party processor with un encrypted credit card number.

Step 413: Server clears credit card number and device key from memory.

Step 414: After transaction completes, user is prompted to provide shipping details. If shipping details were already stored, then he can change them.

Step 415: User taps/clicks “Submit”.

Step 416: User is presented with a thank you page and is sent a confirmation email with details of the purchased goods.

FIG. 5 is an example of a second Use Case for the method of FIG. 3, in which advertisers are selling physical goods that do not require shipping. The method of FIG. 5 may include any subset of the following steps in any suitable order and may employ teachings of co-pending published PCT application WO 2013150530.

Step 501: User clicks/taps the invitation.

Step 502: The SDK calls the in-invitation server and presents user the required product data.

Step 503: User clicks/taps “Buy Now” button.

Step 504: First time users are presented with a payment details form to fill in. Others e.g. second time users, are presented with previously stored payment details.

Step 505: Onetime payment authorization value is created by the device. This authorization value is used for preventing duplicate transactions and preventing copy attack.

Step 506: Private Key and payment authorization value are encrypted by the network key and sent to the server.

Step 507: Server decrypts the authorization value and device key.

Step 508: Authorization value is verified for transaction validity.

Step 509: Server loads relevant credit card record from DB.

Step 510: Decrypt the encrypted credit card number using server private key.

Step 511: Decrypted value is decrypted again using the device key.

Step 512: Payment processing instruction is sent to 3^{rd} party processor with un encrypted credit card number.

Step 513: Server clears credit card number and device key from memory.

Step 514: After transaction completes, user is presented with a thank you page and is sent a confirmation email with details of the purchased goods.

An Application Programming Interface (API) may be provided which acts as an interface for users to access features of underlying applications or platforms and may include specifications used to interface between different software programs. One or more SDKs (Software Development Kits) may be provided to access the API and may include development tools and prewritten codes to facilitate software development based on the API.

It is appreciated that according to certain embodiments, an SDK e.g. as shown and described herein may be packaged in a banner invitation. If the banner invitation is not a mobile invitation then the invitation source may redirect a user who elects to interact with the banner ad to a web page in the computerized payment technology described herein.

All references to advertising banners containing in-invitation payments SDK and the like may therefore be regarded as but one alternative implementation, whereas another alternative employs a hyperlink to a webpage with embedded payment technology pages, e.g. as described herein.

Any suitable platform or system may be employed to facilitate the methods for providing invitations to users, including allowing within-invitation consummation of invitations by end-users e.g. as described above with reference to FIGS. 2-5. For example, an invitation server may be provided for injecting a suitably formatted frame, typically compressed, e.g. IFrame, to the host's page with a dedicated invitation presentation page as well as providing appropriate content for one or more subsequent invitation pages allowing a user to engage with and consummate the invitation. The term “checkout” is used herein to refer to consummating an invitation by allowing an end user to enlist to comply with whatever the invitation proposes, such as becoming a volunteer, answering a survey, performing an ergonometric change, accepting or providing content, performing an e-commerce purchase, and so on. As a checkout solution the system may be operative for providing an SDK to integrate between the invitation server and the checkout process and to provide a checkout SDK to complete the purchase.

Typically, e.g. as shown in FIG. 1, communication is provided between four different domains:
a. Invitation source domain
b. Publisher domain
c. adServer domain
d. checkout domain e.g. as per the teachings of published PCT application WO 2013150530.

An SDK may be designed for the adServer script code and may even include only a single API call: startCheckoutAd, which may be triggered by an onclick call for the corresponding banner. Functionality of the invitation server may include ability to communicate with a Checkout SDK associated with the checkout domain e.g. as per the teachings of published PCT application WO 2013150530.

This startCheckoutAd API is operative for calling an Invitation Server getCheckoutAd API, e.g. as per the teachings of published PCT application WO 2013150530.

Since the checkout is not created at the invitation source's domain, the In-Invitation solution typically makes logic decisions for the invitation source domain e.g. based on a suitable rule engine that follows logic rules that can be defined in accordance with local system considerations in combination with considerations on the part of the invitation source e.g. advertiser. The checkout functionality may be integrated with the invitation source domain's ERP (enterprise resource planning) or CRM (customer relationship management) systems or other data systems in order to query (e.g. about inventory) before showing a banner and subsequent invitation pages. If one invitation is not suitable as determined e.g. from a query to the corresponding invitation source domain's ERP systems, the AdServer may show a different invitation as per pre-defined logic rules.

Alternatively or in addition, data may be collected on users of the system herein in order to match suitable invitations to various users and classes there e.g. using Big Data Analytics and/or computerized analysis of structured data processes generally.

The Invitation Server of FIG. 1 is typically operative for:
1. Starting a new transaction on behalf of the invitation source domain; including verifying invitation suitability e.g. product availability; and/or
2. Delivering suitable invitation pages, e.g. once an initial banner has been clicked/tapped, to the user's browser.

Optionally, an interface to invitation source domains may assist in management of invitation “campaigns” and content presented within the invitation's sequence of pages. Once an invitation has been chosen, a corresponding invitation page may be sent to the user's browser, rendered according to the device screen size and other screen characteristics.

Once an invitation page has been delivered to the user's browser, the page is displayed to the user, typically in an optimized manner from a UI (user interface) and UX (user experience) standpoint, according to the device the page is rendered on. Thus, a user who uses a mobile device, has invitation pages, including a checkout page, which are optimized for mobile interaction, and a user who uses a desktop has invitation pages, including a checkout page, which are optimized for desktop interaction. Browser and device detection abilities, as well as UX abilities, may be employed to optimize the invitation presentation service.

When the user elects to consummate the invitation e.g. by clicking on a suitable button (corresponding to the pay button on conventional product pages), an SDK may trigger a startZoozCheckout API call operative to open an invitation consummation page e.g. (for ads) payment screen immediately at the same place on the publisher's domain and enable 1-click checkout.

The user consummates the invitation e.g. completes the transaction proposed by the invitation on the checkout platform and, once the transaction is completed, the system notifies the invitation source domain of completion of the process. Notification can occur in the background (e.g. Push Notification to the invitation source's URL) or directly by redirecting to the invitation source's page. According to certain embodiments, the hosting website (e.g. invitation source domain or publisher domain) controls which domain gets to keep the traffic e.g. whether or not the invitation source domain is entitled to redirect the traffic to its own page.

According to certain embodiments, a unified platform for interacting with computerized invitations is provided and each computerized invitation comprises an e-commerce invitation. Typically, the system increases conversion rates, and reduces publishers' user-browser abandonment rate.

The system typically includes any subset of or all of the following e.g. as shown in FIG. 1:

Payment Platform

Invitation Server

Invitation source Platform

Invitation source API

Publisher API

The Payment Platform may comprise a server integrated with multiple acquirers, processors & eWallets and may be operative to process transactions with the acquirers or eWallets. The invitation server of FIG. 1 may also provide a smart routing to several acquirers in order to increase the transaction processing success rates.

The Invitation Server may include a data repository that contains all the invitation source's ads (banners, text ads, etc), the product details, and product information. The publisher that holds the product banners may need to integrate to Invitation Server in order for them to be able to show the relevant banners and to open a product page per user and browser interaction.

The Invitation source Platform may comprise a invitation source's back office application e.g. portal, in which the invitation source can update their product lines, images, price, information, and/or setup some or all of: payment options, integration setup, IPN settings.

The invitation source APIs may be divided into two API sets:

Payment APIs and Product API.

The Payment APIs may include some or all of the following APIs:
openTrx—In order to start the payment process, openTrx API call to open a request using a secured channel to the invitation server of FIG. 1 to create a new payment transaction. The openTrx call returns a payment token used to uniquely identify the transaction at a later stage, relative to all other transactions handled by the system.
getPaymentMethods—This call returns a list of all existing payment methods for a specific user, e.g. use of one or more credit or e-commerce cards.
Authorize—This call performs authorization with a specified amount for a specific credit card.
commitPayment—This call captures payment, including capturing a previously authorized amount. CommitPayment can be called only on previously authorized payment.
cancelPayment—This call cancel a specific pending/authorized transaction. If transaction was already captured (committed), this API call may return an error message.
removePaymentMethod—This call removes an existing payment method for a specific user.
getTransactionDetails—Get transaction details with Payment Token API. This allows complete transaction details and transaction statuses to be retrieved before and/or after commit or refund. This call typically does not change the transaction state.
removePaymentMethod—To initiate an API request, call zoozApi.removePaymentMethod(removePaymentMethodRequest,succFunc, failFunc), where succFunc and failFunc are callback functions (e.g. as per code example below) and removePaymentMethodRequest is a JavaScript object

### Code Example

Client Side

<script type=“text/javascript” src=“<ZooZ
Environment>/mobile/checkoutapi/js/checkout-ext- api.js”></script>
And
var initParams = {
isSandbox : true , // Please note: when going live, this value must change
to false
uniqueId:<bundle Id> // App's unique ID as registered in a developer
portal associated with the system of Fig. 1};

Product API set may include some or all of:
addProduct—adding new product to a suitable data repository
removeProduct—removes an existing product from repository
changeProduct—changing existing product details
setProductPaymentMethod—allows the invitation source to enforce payment option per product
setProductSubscription—allows to set a product as a subscription product
setProductDiscount—allows to set a discount amount per product
getStatistics—return CTM, CTA, CTR information

Publishers API set may include some or all of:
getAd—retrieves a specific Invitation from Invitation Server, Retrieves Invitation with a specific size from AdServer—API returns a JSON (JavaScript Object Notation) with two elements:
   Invitation URL (usually retrieves banner image URL)
   onClick JavaScript for the selected/retrieved banner
getStatistics—returns data such as but limited to some or all of:
   CTR=click through rate

FIGS. 6a-6b, taken together, are a simplified flowchart illustration of a variation on the method of FIG. 2 and may for example serve as an example method of operation for the system of FIG. 1. Any of the steps of FIGS. 2, 6a-6b may be combined in any suitable manner FIGS. 6a-6b may include any or all of the following steps, suitably ordered e.g. as follows:

Step 1010. publisher server sets up with many invitation networks and servers, one of them is the invitation server of FIG. 1 or, say, any invitation network e.g. ad network which operates in cooperation with that invitation server

Step 1020. The invitation source sends invitation server (offline) data for generating banner e.g. banner creative, parameters to be displayed, etc.

Step 1030. end-user goes to the publisher domain, and asks to access a content item e.g. read an article

Step 1040. publisher server gets the end-user's request. Preparatory to generating an HTML response for the end-user, publisher sends a request to invitation server of FIG. 1 to get javascript code underlying banner.

Step 1050. invitation server sends javascript (e.g.) code underlying the banner to publisher server

Step 1060. publisher server generates a HTML (e.g.) response back to the end user's browser. HTML response includes inter alia embedded code from invitation server of FIG. 1

Step 1070. HTML sent by publisher's server is downloaded to the end-user's browser and the end-user decides to click the banner.

Step 1080. end-user's click triggers execution of the Javascript code underlying the banner. This sends a request to invitation server of FIG. 1

Step 1090. responsively, invitation server of FIG. 1 may send an HTML response back to the end-user's browser with HTML code which:
a. opens a hover like window on top of the publisher content currently present in user's browser (using IFRAME or any other HTML5 code)
b. displays, inside the window, an invitation including invitation consummation information such as product page, checkout page. If more than one page of invitation consummation information is provided—say 2 pages including a first page having a first button (say: product page with “buy” button) and a second page having a second button (say: checkout page with “pay” button)—then the user clicks the first button on the first page and this click (or tap or similar) sends another Javascript request to the ad server of FIG. 1, and the response HTML includes the second page
c. closes the window once the end user consummates the invitation
d. Preferably, the window is smaller than the screen size such that even when the window is open, some publisher content remains visible (e.g. the window appears in the screen center and publisher content remains visible around (peripheral to) the window. preferably, the HTML response includes an instruction to modify e.g. blur or tint or binarize the publisher content which remains visible, so as to focus the end-user's attention on the window rather than on the publisher content which remains visible.

Optionally, an automatic instruction is provided to refresh the publisher content which the end-user has now been returned to, once the end user has consummated the invitation and the window has been closed.

Steps b and/or d may be performed by “event handling”; both events may be handled by a suitable SDK. The actions that are taken on the event handler may employ suitable “business logic” and may for example employ dynamic loading of content.

It is appreciated that a pop window may for example be opened by dynamically inserting an html div element to the page. Typically, suitable scripts create this element and provide the element with suitable style properties in order to cause the element to appear as a modal window. For example, position fixed may be employed, and/or a very high z-index that makes the element appear above any existing html elements in the invitation source's page. In some cases absolute positing may be employed in order to achieve the same goal.

1100. the end-user consummates the invitation (e.g. end-user clicks button on last invitation consummation page e.g. clicks “PAY” on checkout page)
1110. responsively, suitable Javascript code which includes user information relevant to invitation consummation, may be sent to the invitation server of FIG. 1
1120. invitation server sends back HTML response closing the window opened in with status of payment (success or failure).

Any of the steps of FIGS. 2, 6 may be combined in any suitable manner. It is appreciated that step 1050 may include any or all of steps 3-7 of FIG. 2, for example.

It is appreciated that according to certain embodiments, as above, the content of the publisher website which is still visible during interaction with the invitation is never possessed by the system of FIG. 1 and is modified e.g. blurred by suitably instructing, e.g. by suitable html code, the end-user browser. However alternatively, the blurring or other modification may be performed by the ad-server of publisher or any other node which has or obtained, e.g. by screen-capture, the publisher content to be modified so as to create visual differentiation between that content and the invitation content.

A particular feature of certain embodiments is that when the user finishes interacting with a banner or other invitation injected onto a content page, the user is returned to the content page, e.g. because when a banner or invitation is clicked/tapped by an end-user who is interacting with a content page including the banner, a window is opened, by the end-user's browser, on top of that content page, and as soon as the user has finished interacted with the banner (e.g. has consummated the invitation), the window is closed, causing the user to be returned to the content page. Another particular feature of certain embodiments is that as long as the user is interacting with a banner or other invitation injected onto a content page, some content from the content page continues to be presented within the end user's display screen. This may be effected either via the methods shown and described herein, via screen-capturing, or via any other suitable technical means. An advantage is that this continuity of display gives the end-user a feeling of continuity in that the episode of interacting with the banner or invitation is correctly represented, on the screen, as a parenthetic interlude in the user's main session which is with the content page. In contrast, conventional systems when responding to a banner click or other engagement of end-user with an invitation, generate code which redirects the user to the invitation source website, rather than generating code to open a window as occurs according to certain embodiments of the present invention.

It is appreciated that content may be displayed in accordance with any suitable standard and the display standards referred to herein are merely by way of example. For example, content need not be held in an inline frame (e.g. Iframe) and may, say be replaced by an Object tag; any suitable HTML element (say), may be utilized for displaying the invitation (e.g. div). A checkout process may be effected within a different domain, if desired, e.g. for security reasons. A particular advantage of certain embodiments herein is that a plurality of invitation sources, each of which inject an invitation, all conduct transactions with a population of networked users (e.g. of desktop or mobile devices) and all the invitation sources avail themselves of user particulars stored at a single location, rather than eliciting and storing the same particulars separately at a plurality of use particular repositories each accessible to only one of the invitation sources. This is advantageous because (a) security needs only be provided for a single repository; (b) users need only enter their particulars once, rather than many times for many different transactions vis a vis many different invitation sources from among the plurality of invitation sources; and (c) total security for user particulars is enhanced because user particulars are stored only at a single location, rather than being stored at a plurality of such locations such that “the chain is as strong as its weakest link” i.e. such that the users' particulars are only as secure as the security arrangements of the least secure of the plurality of repositories containing these particulars.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present invention, inter alia, are electromagnetic signals carrying computer-readable instructions for performing any or all of the steps or operations of any of the methods shown and described herein, in any suitable order including simultaneous performance of suitable groups of steps as appropriate; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including at least one processor and/or cooperating input device and/or output device and operative to perform e.g. in software any steps shown and described herein; information storage devices or physical records, such as disks or hard drives, causing at least one computer or other device to be configured so as to carry out any or all of the steps of any of the methods shown and described herein, in any suitable order; at least one program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; at least one processor configured to perform any combination of the described steps or to execute any combination of the described modules; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as Smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including method steps, which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to, those described in the Background section or in publications mentioned therein.

Conversely, features of the invention, including method steps, which are described for brevity in the context of a single embodiment or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the steps illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A system for displaying computerized invitations to end users, the system including:
an invitation server, networked to a multiplicity of end-user's browsers via a network, and operative to send a response to an individual end-user's browser,
wherein said response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to said publisher content previously selected by her or him.

2. A system according to claim 1 wherein said response comprises html code.

3. A system according to claim 1 wherein IFRAME code is used to command the browser to open a window on top of publisher content currently present in user's browser.

4. A system according to claim 1 wherein the invitation includes more than one page each page including a user input area and wherein when the user engages with the user input area on the i'th page, a request is sent to the invitation server for the (i+1)'th page.

5. A system according to claim 4 wherein said request comprises a Javascript request.

6. A system according to claim 1 wherein the window is smaller than the screen size such that even when the window is open, some publisher content remains visible.

7. A system according to claim 6 wherein the window appears in the screen center and publisher content remains visible in an area peripheral to the window.

8. A system according to claim 6 wherein said response includes an instruction to modify the publisher content which remains visible, so as to focus the end-user's attention on the window rather than on the publisher content which remains visible.

9. A system according to claim 8 wherein said instruction to modify includes an instruction to blur the publisher content which remains visible.

10. A system according to claim 8 wherein said instruction to modify includes an instruction to tint the publisher content which remains visible.

11. A system according to claim 8 wherein said instruction to modify includes an instruction to binarize the publisher content which remains visible.

12. A system according to claim 4 wherein said user input area comprises a button and wherein the user engages therewith by at least one of clicking and tapping.

13. A system according to claim 1 wherein the invitation server is also operative, once the end user consummates the invitation, to update affected nodes in the network.

14. A method for displaying computerized invitations to end users, the method including:
providing an invitation server, networked to a multiplicity of end-user's browsers via a network, and operative to send a response to an individual end-user's browser
wherein said response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to said publisher content previously selected by her or him.

15. A computer program product, comprising a non-transitory tangible computer readable medium having computer readable program code embodied therein, said computer readable program code adapted to be executed to implement a method for displaying computerized invitations to end users, the method including:
using an invitation server, networked to a multiplicity of end-user's browsers via a network, to send a response to an individual end-user's browser wherein said response is operative to command the individual end user's browser to:
a. open a window on top of publisher content previously selected by the individual end-user and currently present in user's browser;
b. display, inside the window, an invitation including invitation consummation information allowing the individual end user to consummate the invitation, and
c. close the window once the individual end user consummates the invitation, thereby returning her or him to said publisher content previously selected by her or him.
